(19) United States
(12) Patent Application Publication
(10) Pub. No.: US 2024/0147986 A1
(43) Pub. Date: May 9, 2024

(54) CARRIER FOR CRYOPRESERVATION OR THAWING AND RESUSCITATION OF BIOLOGICAL TISSUE

(71) Applicant: Shen Zhen Biorocks Biotechnology Company Limited, Shenzhen (CN)

(72) Inventors: Ho Nam Chan, Tseung Kwan O (CN); Yiwei Shu, Tseung Kwan O (CN)

(21) Appl. No.: 18/279,983

(22) PCT Filed: Mar. 1, 2022
(86) PCT No.: PCT/CN2022/078602

§ 371 Date: Sep. 1, 2023

(30) Foreign Application Priority Data
Mar. 3, 2021 (CN) 202120458116.5

(51) Int. Cl. A01N 1/02

(52) U.S. Cl. CPC A01N 1/0263

(57) ABSTRACT

Disclosed in the present utility model is a carrier for cryopreservation or thawing and resuscitation of biological tissue. The carrier includes: a carrier rod body and a sleeve sleeved on the carrier rod body, wherein the front end of the carrier rod body is provided with a first recess for an embryo to be placed therein. The carrier of the present utility model can keep biological tissue at a relatively fixed position during cryopreservation or thawing and resuscitation of the biological tissue; and it is simple to operate and improves the efficiency.

### TECHNICAL FIELD

The utility model relates to the technical field of bioengineering, in particular to a carrier for cryopreservation or thawing and resuscitation of biological tissue.

### BACKGROUND

Cell cryopreservation is an important technology in many biological fields, as is the restoration of cells from a cryopreserved state to a normal metabolic state. This process of thawing and resuscitation involves a process of removing cryoprotectant and replacing it with normal culture medium.

The device used in the freezing or thawing of embryos in the prior art has the problems of complex operation, low efficiency and the like.

### SUMMARY

The utility model mainly aims at providing a carrier for cryopreservation or thawing and resuscitation of biological tissue, so as to solve the problems of complex operation, low efficiency and the like in the freezing or thawing process of embryos with the carrier of the prior art.

According to the embodiment of the utility model, a carrier for cryopreservation or thawing and resuscitation of biological tissue, comprising: a carrier rod body, and a sleeve sleeved on the carrier rod body, wherein a front end of the carrier rod body is provided with a first recess for an embryo to be placed therein.

Wherein, the first recess is funnel-shaped.

Wherein, the carrier rod body includes a front-end sheet and a rear-end carrier rod, and the first recess is arranged on the front-end sheet.

Wherein, a second recess is further arranged on the front-end sheet, and the second recess is located at a rear end of the first recess.

Wherein, the second recess runs through an upper surface of the front-end sheet.

Wherein, the carrier rod body is provided with a first annular boss and a second annular boss, and the first annular boss is located at a rear end of the second annular boss.

Wherein, the inner surface of the sleeve is provided with an elastic buckle engaged with the first annular boss and the second annular boss.

Wherein, when the elastic buckle is engaged with the first annular boss, the front-end sheet of the carrier rod body is exposed outside the sleeve.

Wherein, when the elastic buckle is engaged with the second annular boss, the front-end sheet of the carrier rod body is covered by the sleeve.

According to the technical solution of the utility model, by providing a carrier including a carrier rod body and a sleeve, and arranging a first recess for an embryo to be placed therein at the front end of the carrier rod body, the carrier can keep biological tissue at a relatively fixed position during cryopreservation or thawing and resuscitation of the biological tissue; and the carrier is simple to operate and can improve the efficiency.

### BRIEF DESCRIPTION OF THE DRAWINGS

The drawings described herein are used to provide a further understanding of the utility model and form a part of the present application. The illustrative embodiments of the utility model and the description thereof are used to explain the utility model and are not unduly limiting the utility model. In the drawings:

FIG. 1 is a schematic diagram of a carrier according to an embodiment of the utility model;

FIG. 2 is a schematic diagram of a carrier according to another embodiment of the utility model;

FIG. 3 is a schematic cross-sectional view of a first recess according to an embodiment of the utility model;

FIGS. 4A and 4B are enlarged partial views of A in FIG. 2;

FIGS. 5 and 6 are schematic diagrams of a sleeve covering the front-end sheet according to an embodiment of the utility model;

FIG. 7 is an enlarged partial view of B in FIG. 6.

### DETAILED DESCRIPTION

In order to make the purpose, technical solution and advantages of the utility model clearer, the technical solution of the utility model will be clearly and completely described below in combination with the specific embodiments of the utility model and the corresponding drawings. Apparently, the described embodiments are only part of the embodiments of the present utility model, but not all of them. Based on the embodiments in the utility model, all other embodiments obtained by persons of ordinary skill in the art without making creative labor are within the scope of protection of the present utility model.

The utility model provides a carrier, which is a device for cryopreservation or thawing and resuscitation of biological tissue, wherein, the biological tissue can be embryos, eggs, cells, and other biological materials, which are not limited in this application.

The technical solution provided by various embodiments of the present utility model is described below in detail with reference to the accompanying drawings.

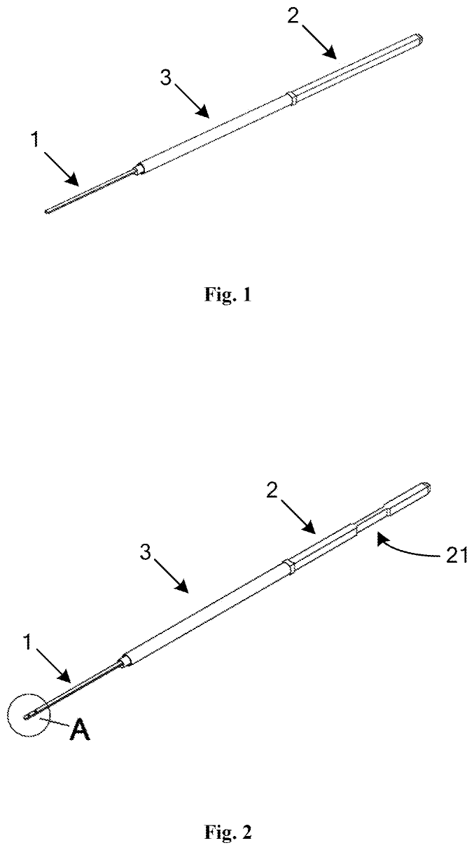

Referring to FIG. 1, the carrier according to the embodiment of the utility model includes: a carrier rod body and a sleeve 3. The carrier rod body is generally a strip-shaped structure and includes a front-end sheet 1 and a rear-end carrier rod 2. The sleeve 3 is sleeved on the carrier rod body, the length of the sleeve 3 is less than that of the carrier rod body, and the sleeve 3 can slide back and forth on the carrier rod body to cover or expose the portion of the front-end sheet 1 of the carrier rod body.

With reference to FIG. 2, the front-end sheet 1 can be made of a plastic material with uniform thickness, transparent material, biological compatibility and good heat transfer properties, so as to ensure the applicability for holding embryos and the speed of heat transfer during subsequent freezing. The rear-end carrier rod 2 can also be referred to as a handle or a handpiece and is a position where the operator's hand is in direct contact to perform the operation. The rear-end carrier rod 2 may have a certain width so that a label 21 recording information about an embryo to be processed is provided on the surface of the rear-end carrier rod 2.

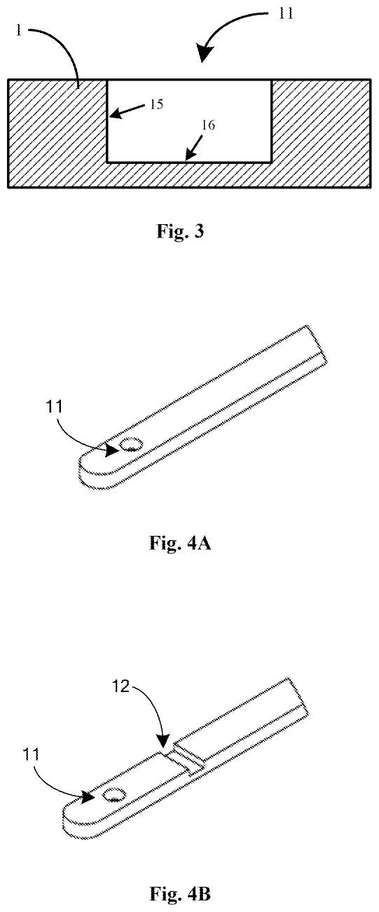

With reference to FIGS. 3 and 4A, the front end of the front-end sheet 1 is provided with a first recess 11 for holding an embryo to be processed and an associated solution for protecting the embryo. Generally, the volume of the first recess 11 may be 10 nanoliters to 1 microliter. In some embodiments of the present application, the first recess 11 has a wall 15 and a bottom 16, and the angle between the wall 15 and the bottom 16 can be designed to be a vertical structure of 90°, which can reduce the risk of embryos gradually overflowing along the wall along with the flow of solution in the recess and improve the control of the position of embryos in the recess. In some embodiments, the angle between the wall 15 and the bottom 16 may be further designed to be smaller than 90°, thereby further increasing the difficulty for the embryo to overflow the recess along the wall.

Referring to FIG. 4B, in some embodiments of the present application, a second recess 12 is further provided at the rear end of the first recess 11 on the front-end sheet 1, wherein the second recess 12 may be a cuboid-shaped recess running through the upper surface of the front-end sheet 1.

When the carrier comes into contact with other devices, some bubbles will be trapped in the gap between the carrier and other devices. When other devices move relative to the carrier, these trapped bubbles will be pushed into the first recess, which will affect the automatic freezing/thawing effect. When the bubbles are pushed into the second recess, the bubbles will be trapped. Due to the surface tension of the solution, the bubbles in the second recess will not re-enter the slit between the biochip and the carrier in the process of relative movement, so the bubbles will not reach the position of the first recess, thus achieving the purpose of improving the automatic freezing/thawing effect.

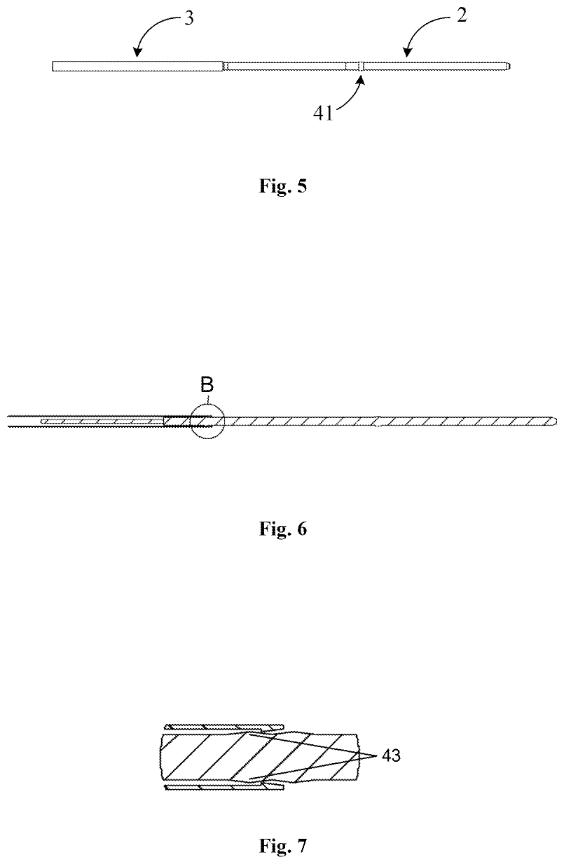

Referring to FIGS. 5 to 7, the carrier rod body is provided with a first annular boss 41, and the inner surface of the sleeve 3 has an elastic buckle, which can be engaged with the first annular boss 41. When the elastic buckle is engaged with the first annular boss 41, the front-end sheet 1 of the carrier rod body is exposed outside the sleeve 3 (as shown in FIG. 1 or FIG. 2), that is, the first recess 11 and the second recess 12 are both exposed, so that the cryopreservation or thawing and resuscitation operations of embryos can be performed. As shown in the figures, the carrier rod body is also provided with a second annular boss (at position B in FIG. 6), on which the carrier rod body is provided with a protrusion mechanism 43, and the buckle of the sleeve 3 can engage the protrusion mechanism 43, wherein the second annular boss is located at the front-end position of the first annular boss. The elastic buckle of the sleeve 3 can be engaged with the second annular boss. When the sleeve 3 is pushed forward, the elastic buckle of the sleeve 3 is detached from the engagement with the first annular boss 41, and the sleeve 3 slides forward. When the elastic buckle of the sleeve 3 is in contact with and engaged with the second annular boss, the front-end sheet 1 of the carrier rod body is covered by the sleeve 3 (referring to FIG. 5), that is, both the first recess 11 and the second recess 12 are covered, thus effectively protecting the first recess 11 (and the embryo therein). It should be noted that in other embodiments of this application, other engaging connection modes can also be adopted between the carrier rod body and the sleeve, which is not limited in this application.

In addition, the sleeve can also be separated from the carrier rod body as a whole. In some processing processes of cryopreservation or thawing and resuscitation of embryos, the carrier rod body detached from the sleeve is more conducive to operation.

The above descriptions are only embodiments of the utility model, and are not intended to limit the utility model. For persons skilled in the art, various modifications and changes can be made to the utility model. Any modifications, equivalent replacements, improvements, etc. made within the spirit and principles of the utility model shall be included within the scope of the claims of the utility model.

1. A carrier for cryopreservation or thawing and resuscitation of biological tissue, comprising a carrier rod body and a sleeve sleeved on the carrier rod body, wherein a front end of the carrier rod body comprises a first recess for an embryo to be placed therein.

2. The carrier according to claim 1, wherein an angle between a wall and a bottom of the first recess is ≤90°.

3. The carrier according to claim 1, wherein the carrier rod body comprises a front-end sheet and a rear-end carrier rod, and the first recess is on the front-end sheet.

4. The carrier according to claim 1, wherein a second recess is on the front-end sheet, and the second recess is located at a rear end of the first recess.

5. The carrier according to claim 4, wherein the second recess runs through an upper surface of the front-end sheet.

6. The carrier according to claim 1, wherein the carrier rod body comprises a first annular boss and a second annular boss, the first annular boss being located at a rear end of the second annular boss.

7. The carrier according to claim 6, wherein an inner surface of the sleeve comprises an elastic buckle engaged with the first annular boss and the second annular boss.

8. The carrier according to claim 6, wherein when the elastic buckle is engaged with the first annular boss, the front-end sheet of the carrier rod body is exposed outside the sleeve.

9. The carrier according to claim 6, wherein when the elastic buckle is engaged with the second annular boss, the front-end sheet of the carrier rod body is covered by the sleeve.
